(19) United States
(12) Patent Application Publication
(10) Pub. No.: US 2013/0076294 A1
(43) Pub. Date: Mar. 28, 2013

(54) ELECTRIC VEHICLE CHARGING SYSTEM AND METHOD OF SUPPLYING POWER TO AN ELECTRIC VEHICLE CHARGING STATION

(71) Applicant: Gregory Mark Smith, New York, NY (US)

(72) Inventor: Gregory Mark Smith, New York, NY (US)

(73) Assignee: All Vision LLC., New York, NY (US)

(21) Appl. No.: 13/247,242

(22) Filed: Sep. 28, 2011

(51) Int. Cl. H01M 10/46; H02J 7/00

(52) U.S. Cl. 320/101; 320/109

(57) ABSTRACT

An electric vehicle charging system including an electric vehicle charging station configured to provide power for a vehicle, an outdoor media installation functionally associated with the electric vehicle charging station, and a power source electrically connected with the electric vehicle charging station to provide power thereto.

### FIELD

The present disclosure relates generally to an electric vehicle (EV) charging system and a method of supplying power to an EV charging station. More specifically, the disclosure relates to an EV charging station functionally associated with an outdoor media installation so as to provide a power source for the EV charging station and/or to notify vehicle users of the presence of the same.

### BACKGROUND

The statements in this section merely provide background information related to the present disclosure and may not constitute prior art.

Electric vehicle (EV) technology provides an alternative to gas vehicle technology and/or a way to improve the efficiency of gas vehicle technology. EV technology may be environmentally and/or socially beneficial depending on the means by which the electricity is generated. EV technology may be particularly environmentally and/or socially beneficial when the electricity is generated from solar technology.

Perhaps as a result of these and other factors, solar-powered EV charging stations are becoming more common; however, such stations are still far less numerous than traditional gas stations. As a result, it is desirous to advertise and/or provide instructions or directions for locating EV charging stations.

Solar-powered systems generally require a large amount of generally flat surface area to support a sufficient number of solar panels. Particularly in urban environments, such surface area may be difficult or expensive to acquire. Therefore, it is desirous to maximize the available surface area to support solar panels in any solar-powered system.

### SUMMARY

In overcoming the limitations and drawbacks of the prior art, the present system and method provide an EV charging system including an EV charging station configured to provide power for a vehicle, a outdoor media installation functionally associated with the EV charging station, and a power source electrically connected with the EV charging station to provide power thereto.

In one aspect, the power source comprises a photovoltaic system and may be electrically connected to the EV charging station via the outdoor media installation. The photovoltaic system also may include at least one solar panel physically coupled with the outdoor media installation.

In another aspect, the outdoor media installation includes an EV charging station notification and the outdoor media installation is positioned with respect to the EV charging station so as to notify viewers of the presence of the EV charging station in the proximity of the outdoor media installation.

In another aspect, a method of supplying power to an EV charging station includes functionally associating an outdoor media installation with the EV charging station and electrically connecting a power source with the EV charging station to provide power thereto.

In yet another aspect, a solar-power installation may be associated with an outdoor media installation to provide solar-powered assistance to an EV charging station in proximity to the outdoor media installation.

Further objects, features and advantages of the system and method will become readily apparent to persons skilled in the art after a review of the following description, with reference to the drawings and claims that are appended to and form a part of this specification.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows an electric vehicle (EV) charging system including an EV charging station, an outdoor media installation functionally associated with the EV charging station, and a parking area located adjacent to the EV charging station;

FIG. 2 is a schematic diagram depicting the EV charging system shown in FIG. 1;

FIG. 3a is an alternative embodiment of the outdoor media installation shown in FIG. 1, having a tracker system configured to adjust the position of a solar panel with respect to the outdoor media installation and having another solar panel coupled with the front face of the outdoor media installation;

FIG. 3b is another alternative embodiment of the outdoor media installation shown in FIG. 1, having a solar panel coupled with a top portion of the outdoor media installation;

FIG. 4 is an alternative embodiment of an EV charging system having an EV charging station and an outdoor media installation structurally connected with the EV charging station;

FIG. 5a is one embodiment of the EV charging station shown in FIG. 1, wherein the EV charging station is a self-standing component;

FIG. 5b is another embodiment of the EV charging station shown in FIG. 1, wherein the EV charging station is a pole-mounted component; and

FIG. 5c is yet another embodiment of the EV charging station shown in FIG. 1, wherein the EV charging station is a wall-mounted component.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

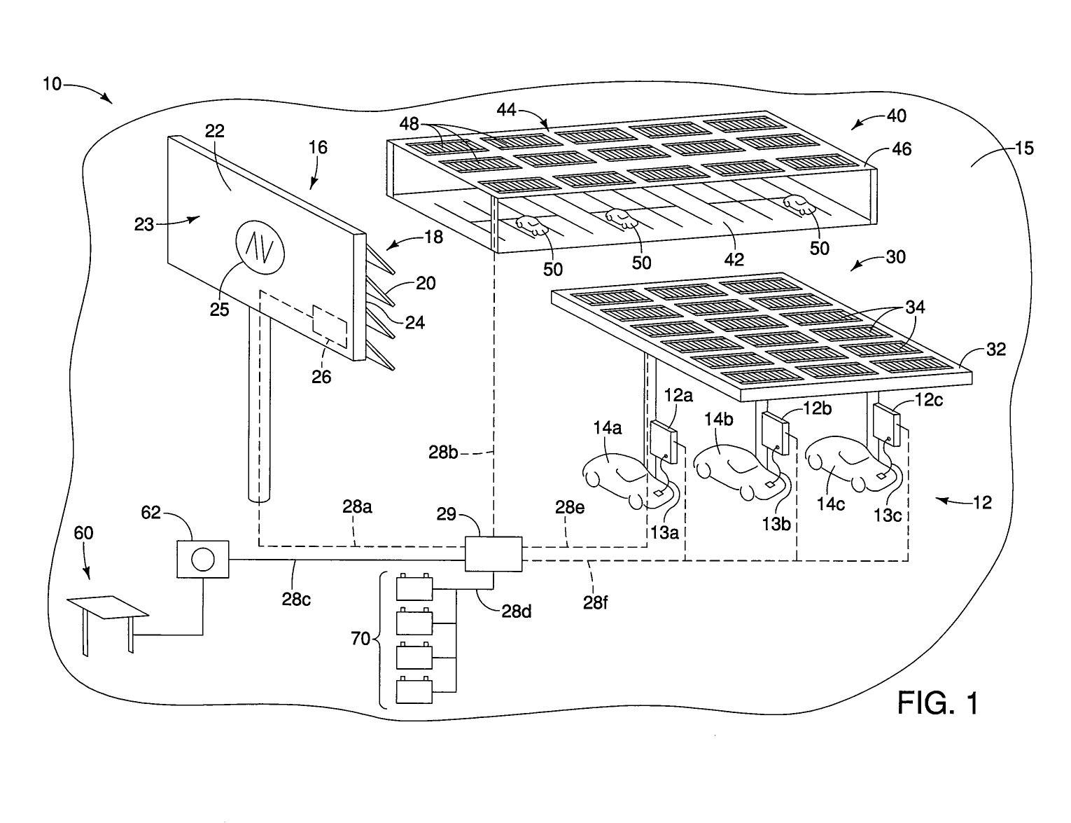

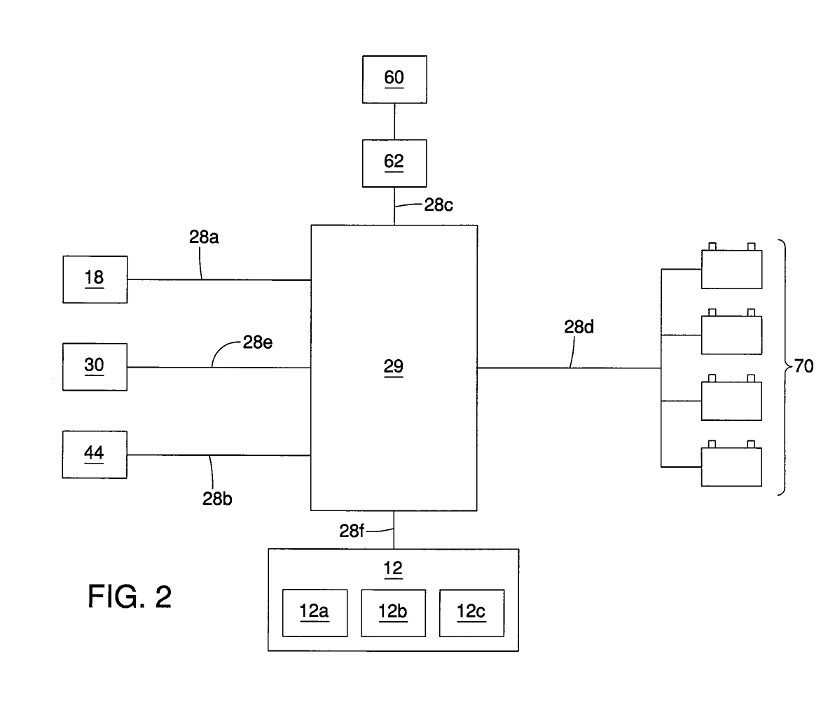

Referring now to the drawings, FIGS. 1 and 2 show an EV charging system 10 generally including an EV charging station 12 configured to provide power for a vehicle 14, an outdoor media installation 16 functionally associated with the EV charging station, and a power source, such as a photovoltaic system 18, electrically connected with the EV charging station 12 to provide power thereto. The EV charging system 10 shown in the figures also includes a second power source, such as a second photovoltaic system 30 positioned above the EV charging station 12. The EV charging system 10 shown in the figures also includes a third power source, such as a third photovoltaic system 44 positioned adjacent to a vehicle parking area 40.

The EV charging station 10 is contained within and supported by a base area 15, such as developed or undeveloped property. For example, the property comprising the base area 1 5 may include bare earth, concrete, landscaping, or a combination thereof. The base area 15 in FIG. 1 contains and supports the EV charging station 12, the vehicle 14, the outdoor media installation 16, the photovoltaic system 18, the second photovoltaic system 30, the vehicle parking area 40, and the third photovoltaic system 44.

The EV charging system 10 may be located near a freeway or highway entrance or exit or public transportation corridor or facility. In the present embodiment, the EV charging system is located near one of a plurality of vehicle parking facilities, wherein the parking facilities may contain vehicle parking spaces devoted to the charging of electric vehicles. As a result, the vehicle parking area 40 shown in the figures may include parking spaces 42 for vehicles 50 for uses such as a “park and ride” service with public transportation or as a “carpool lot” for carpoolers to meet and park one or more vehicles.

The EV charging station 12 shown in the figures includes three stations 12a, 12b, 12c but any suitable number of stations may be used with the EV charging system 10 described herein. Each of the EV charging stations 12a, 12b, 12c includes a charging cable 13a, 13b, 13c capable of being electrically connected to a vehicle 14 so as to charge the battery of the vehicle 14. In FIG. 1, three vehicles 14a, 14b, 14c, while being charged, are physically positioned adjacent to and electrically connected to the three stations 12a, 12b, 12c via the charging cables 13a, 13b, 13c so as to charge the batteries of the vehicles 14a, 14b, 14c.

The vehicles 14a, 14b, 14c shown in the figures are electric vehicles. For the purposes of this application, the terms “electric vehicle” and “EV” refer to vehicles, such as cars, trucks, motorcycles, scooters, planes, boats, helicopters, hovercraft, or any other means of transport that are, at least at times, able to be electrically-powered, even if they may also be driven by a fossil-fuel-powered engine. Furthermore, the terms may also refer to a means of transport in which at least a portion of the vehicle is powered from an electric source, such as a battery, alternator or generator. For example, a car that has an engine that is able to be driven by either an electrical source or a gas source is considered an “electric vehicle” or “EV” as defined herein. As another example, a car that is only able to be driven by an electrical source is considered an “electric vehicle” or “EV” as defined herein.

It should be noted that a car that may be driven primarily by a fossil fuel powered engine, yet having an onboard, chargeable electrical power source such as a battery to power electrical devices such as headlamps and other electronics may also find use through connection to EV charging stations such as those disclosed herein. This includes conventional fossil-fueled vehicles similar to those most common at the time of filing the instant application.

The EV charging station 12 shown in FIG. 1 is able to receive power, via a regulator/generator 29, from some or all of several different sources, including the photovoltaic system 18, the second photovoltaic system 30, the third photovoltaic system 44, a power grid 60, and a battery bank 70 that is able to be charged by any or all of the foregoing power sources. The photovoltaic systems 18, 30, 44 each receive solar energy and convert the same into electricity. The power grid 60 supplies electricity via conventional means, such as coal-burning, hydro-electrical generators, wind or solar powered generators, nuclear power plants, or other energy sources. The battery bank 70 serves to store electricity from the aforementioned power sources as well as to provide electricity to the EV charging station 12. Although the EV charging station 12 shown in FIG. 1 is electrically connected with several different power sources, the station may be used with one or a combination of the aforementioned or other sources.

The regulator/converter 29 is electrically connected to the photovoltaic system 18 via a billboard connection line 28a, to the second photovoltaic system 30 via a charging station roof connection line 28e, to the stations 12a, 12b, 12c via a charging station connection line 28f, to the third photovoltaic system 44 via a park area connector line 28b, to the power grid 60 and an electricity meter 62 via a power grid connection line 28c, and to the battery pack 70 via a battery connection line 28d. The regulator/converter 29 may include all or some of the following components depending on desired system parameters: an inverter for converting power from the photovoltaic system 18 from direct current to alternating current; electrical connections arranged in series configuration to obtain a desired voltage; electrical connections arranged in parallel to increase the current; a blocking diode to prevent battery drain during low insulation; controls or regulators for controlling the electricity flow from the billboard connection line 28a, from the park area connector line 28b, from the power grid connection line 28c, to and from the battery connection line 28d, from the charging station roof connection line 28e, and to the charging station connection line 28f.

The outdoor media installation 16 may display various types of media, such as still images, rotating or alternating images, or videos. The outdoor media installation 16 may employ lights or other elements to illuminate the outdoor media installation 16 to viewers. The outdoor media installation 16 shown in FIG. 1 has a front face 22 with a display surface 23 having an area of approximately 300 square feet.

For purposes of the present application, the term “outdoor media installation” generally refers to a relatively large sign, structure or object capable of displaying an image, printed advertising, text, video or any other visual media. The term “outdoor” indicates that the media may be large enough to be easily seen by passing motorists or other vehicles. For example, the outdoor media installation may comprise a billboard structure, such as an elevated billboard or a ground-level structure that includes a panel or face commonly used for the display of advertisements in public places. The outdoor media installation can even comprise a display or mounting structure positioned on an outer wall of a building or other larger structure, or a road sign or other structure suitable for displaying printed or electronic media. In the present embodiments, the surface area or face of the outdoor media installation may in some instances be large enough so that the area that contains advertising material exceeds the surface area of one of the EV chargers disclosed herein. In some of the embodiments herein, the surface area for containing the media is larger than 50 square feet, in other embodiments the surface area is larger than 150 square feet, and in other embodiments the surface area is larger than 300 square feet.

The outdoor media installation 16 as shown includes a front face 22 and a rear face 24, wherein the front face 22 typically displays digital or static text or images such as printed advertisements, company logos, or other information. Further in this regard, the front face 22 may include one or more alphanumeric displays, LED panels or video displays. The outdoor media installation 16, commonly known as sinage, may display any suitable type of information, such as but not limited to marketing or advertisement-supported information, public service messages, or political campaign propaganda. The front face 22 may also include an EV charging station notification 25, as will be discussed in more detail below. The outdoor media installation 16 may also include a non-flat display surface, such as a rounded display surface or any other suitable shape. The outdoor media installation 16 may also include multiple display surfaces, such as a front display face and a rear display face (commonly known as a double-sided billboard).

The photovoltaic system 18 includes at least one solar panel 20 and in FIG. 1 includes a plurality of solar panels 20 that are positioned adjacent to and generally parallel to each other along the rear face 24 of the outdoor media installation 16. The solar panels 20 receive solar rays and convert the same into direct current electricity using semiconductors that exhibit the photovoltaic effect, as is known in the art. The solar panels 20 shown in FIG. 1 may be positioned at one or more angles with respect to the outdoor media installation 16 so as to more effectively receive solar energy from the sun when the sun is at or near a high point in the sky. As will be discussed below in more detail below, solar panels used in the EV charging system 10 may also be movable so as to maximize the amount of solar energy captured as the sun moves across the sky. The solar panels used in the photovoltaic system 18 may be physically connected to a support beam for the outdoor media installation 16 rather than the front or rear faces 22, 24 thereof.

In the present embodiment, the outdoor media installation 16 is functionally associated with the EV charging station 12, which means that at least one of the following conditions is present: (1) the outdoor media installation 16 is electrically connected to the EV charging station 12, and/or (2) the outdoor media installation includes the EV charging station notification 25 and the outdoor media installation 16 is positioned with respect to the EV charging station 12 so as to be able notify viewers of the EV charging station notification 25 of the presence of the EV charging station 12. For the second condition, the shorter the distance between the EV charging station 12 and the outdoor media installation 16 the less detail that is required in the content of the EV charging station notification 25. As an example, the second condition would be satisfied if the outdoor media installation 16 was positioned within one-quarter of a mile of the EV charging station 10 and the EV charging station notification 25 included a logo, name, or symbol for the EV charging station 10 or the EV charging station 10 owner or operating entity. As another example, the second condition would be satisfied if the outdoor media installation 16 was positioned within one-half of a mile of the EV charging station 10 and the EV charging station notification 25 included a message indicating that the EV charging station 10 is “just ahead,” “close,” or “nearby.” As yet another example, the second condition would be satisfied if the outdoor media installation 16 was positioned within two miles of the EV charging station 10 and the EV charging station notification 25 included a message indicating that the EV charging station 10 is “minutes away” or “two miles ahead.” As another example, the second condition would be satisfied if the outdoor media installation 16 was positioned any distance from the EV charging station 10 and the EV charging station notification 25 included directions on how to reach the EV charging station 10 from the location of the billboard sigh 16, such as “five miles ahead, then right” or “Exit 16, then right.”

The outdoor media installation 16 shown in FIG. 1 includes outdoor media installation controls 26 which may operate or control various functions of the outdoor media installation 16 and/or the solar panels 20, such as regulating, converting, storing, or serving as an electrical connector for electricity flowing from the solar panels 20 to the regulator/generator 29.

The second photovoltaic system 30 is positioned above and electrically connected to the EV charging station 12. The second photovoltaic system 30 shown in the figures includes an EV charging station roof 32 with a plurality of solar panels 34. The solar panels 34 receive solar rays and convert the same into direct current electricity using semiconductors that exhibit the photovoltaic effect, as is known in the art. The EV charging station roof 32 shown in FIG. 1, and as a result the solar panels 34, are generally parallel with the ground so as to more effectively receive solar energy from the sun when the sun is at or near a high point in the sky. As will be discussed below in more detail below, the solar panels used in the EV charging system 10 may also be movable so as to maximize the amount of solar energy captured as the sun moves across the sky.

The third photovoltaic system 44 is positioned above the vehicle parking area 40 and is electrically connected to the EV charging station 12. The third photovoltaic system 44 shown in the figures includes a parking area roof 46 with a plurality of solar panels 48. The solar panels 34 receive solar rays and convert the same into direct current electricity using semiconductors that exhibit the photovoltaic effect, as is known in the art. The EV charging station roof 32 shown in FIG. 1, and as a result the solar panels 34, are generally parallel with the ground so as to more effectively receive solar energy from the sun when the sun is at or near a high point in the sky. As will be discussed below in more detail below, the solar panels used in the EV charging system 10 may also be movable so as to maximize the amount of solar energy captured as the sun moves across the sky.

The vehicle parking area 40 may include one or more EV charging stations positioned near the parking spaces 42 so that vehicles 50 may be charged while they are parked. The vehicle parking area may also include multiple levels, such as a multiple-level parking structure, garage, ramp, or other structure suitable for parking vehicles. The multiple-level parking structure may also include solar panels on multiple faces of the building, such as the front, back, sides, and roof.

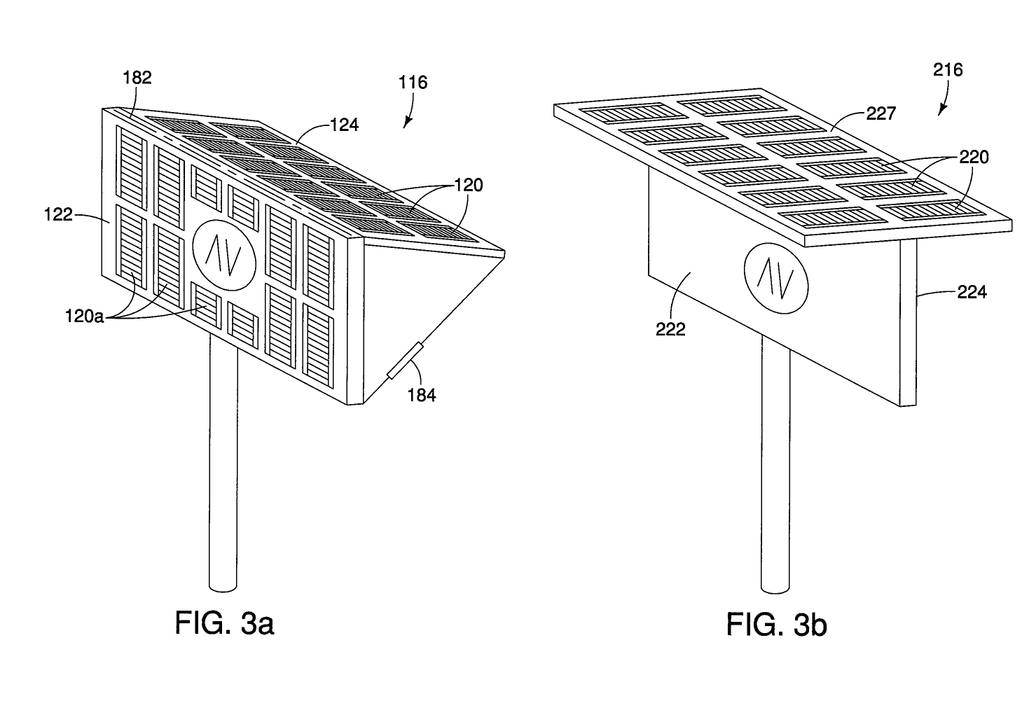

In one alternative embodiment, as shown in FIG. 3a, a outdoor media installation 116 includes a front face 122, a rear face 124, a plurality of solar panels 120 positioned on the rear face 124, and a tracker system 180 configured to adjust the position of solar panels 120 with respect to the outdoor media installation 116 so as to maximize the solar energy collected by the solar panels 120 throughout each day. The tracking system 180 may use a timer system to generally track the predicted position of the sun based on variables such as time of day and time of year. The tracking system 180 may also, or alternatively, use a solar sensor to track the position of the sun. In either case, the tracking system 180 causes the rear face 124 to move as the sun moves across the sky during the day so as to maximize the solar energy collected. For example, the tracking system 180 shown in FIG. 3a includes a pivotable connection along line 182 and a piston 184 or other movable arm to actuate or retract and cause pivoting movement of the rear face 124. The outdoor media installation 116 in FIG. 3a also includes a plurality of solar cells 120a on the front face 122.

In another alternative embodiment, as shown in FIG. 3b, an outdoor media installation 216 includes a front face 222, a rear face 224, and a top portion 227 with a plurality of solar panels 220. The top portion 227 is generally parallel with the ground so as to more effectively receive solar energy from the sun when the sun is at or near a high point in the sky. In another embodiment, the solar panel atop the outdoor media installation has two portions, one portion sloping towards a first face of the outdoor media installation and another portion sloping in the opposite direction towards a second face of the outdoor media installation, not unlike the roof to a house. In this example, the outdoor media installation is preferably relatively thick so as to provide more support for the solar panel. For example, the thickness of the outdoor media installation may be approximately one-half the width of the outdoor media installation. In this example, the outdoor media installation may have display areas on more than one side, such as on a front face and a rear face.

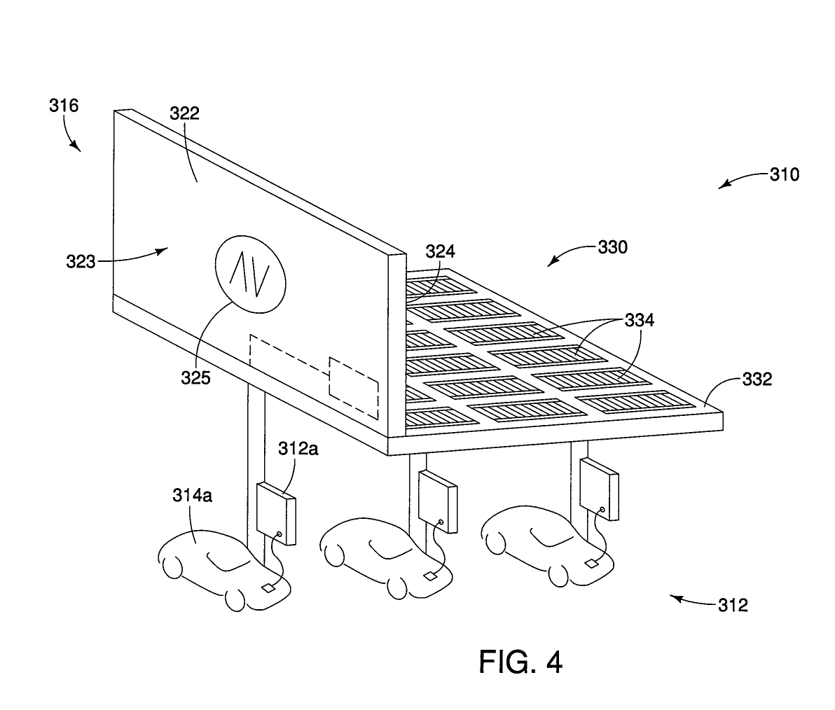

In an alternative embodiment, as shown in FIG. 4, an EV charging system 310 includes an EV charging station 312 configured to provide power for a vehicle 314a, an outdoor media installation 316 structurally connected with the EV charging station 312, and a power source such as a photovoltaic system 330. As with the embodiment shown in FIGS. 1 & 2, the outdoor media installation 316 may display various types of media, such as still images, rotating or alternating images, or videos. The outdoor media installation 316 has a rear face 324 and a front face 322 with a display surface 323 that is displaying an EV charging station notification 25. The charging station 312 includes a plurality of stations 312a connected to vehicles 314a and an EV charging station roof 332. The EV charging station roof 332 shown in FIG. 4 physically supports the photovoltaic system 330, which includes a plurality of solar panels 334. The solar panels 334 receive solar rays and convert the same into direct current electricity using semiconductors that exhibit the photovoltaic effect, as is known in the art.

The outdoor media installation 316 shown in FIG. 4 is positioned generally perpendicular to the EV charging station roof 332 near an edge of the EV charging station roof 332 so that it is generally visible to potential and actual users of the EV charging system 310, but any suitable configuration may be used. For example, the outdoor media installation 316 may be positioned at or near the center of the EV charging station roof 332 or may hang downward (instead of extend upward) from the EV charging station roof 332. The outdoor media installation 316 may be structurally connected with the EV charging station 312 by any suitable means, such as mechanical fasteners or brackets. As an alternative, the EV charging station roof 332 and the outdoor media installation 316 may be formed from a single, unitary component. The outdoor media installation 316 may also be structurally connected to the EV charging station 312 via a connector such as a beam, pole, pillar, or other suitable connector. The EV charging station 312 may also include multiple outdoor media installations structurally connected therewith. As an alternative or a supplemental power source to that shown in FIG. 4, the EV charging system 310 may include a photovoltaic system supported by or connected to the outdoor media installation 316.

In another alternative embodiment, the power source for the EV charging station is generated wholly or in-part by a power source other than solar power. For example, the EV charging system may utilize wind-power, hydro-electric power, fossil fuel, nuclear fuel, a combination or any of these or other suitable power sources. In one such example, one or more wind turbines are positioned atop the outdoor media installation to harness power from the wind. In another such example, wind turbines are fastened to the top of the outdoor media installation to harness wind power and solar panels are fastened to the support structure for the outdoor media installation to harness solar power.

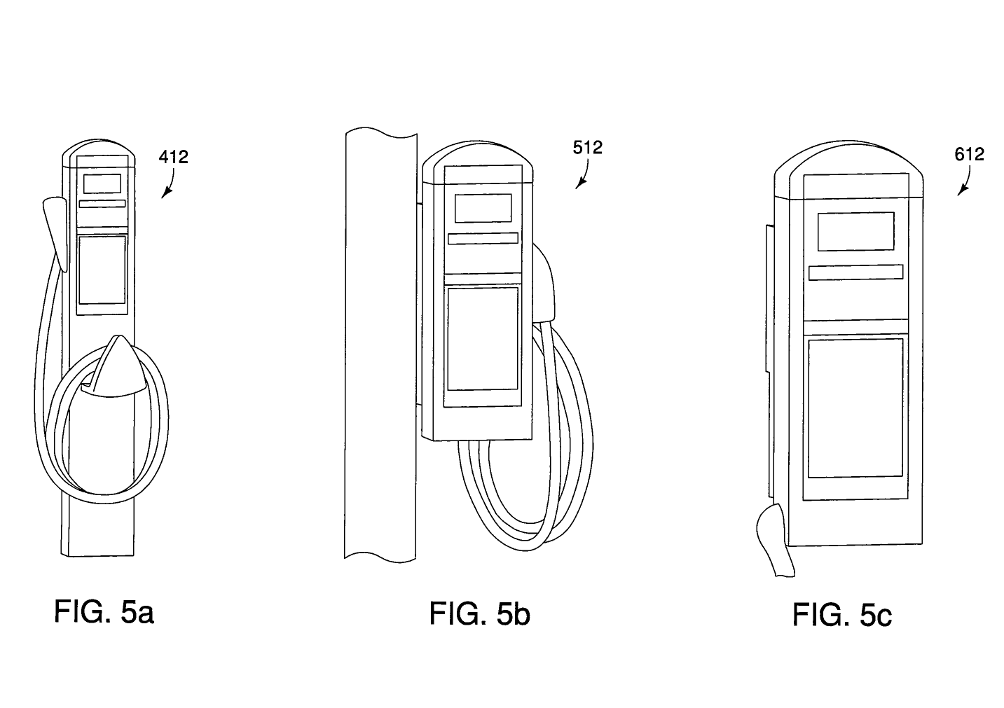

FIGS. 5a, 5b, and 5c show three alternative embodiments of EV charging stations 412, 512, 612. FIG. 5a shows a stand-alone EV charging station 412, FIG. 5b shows a pole-mounted EV charging station 512, and FIG. 5c shows a wall-mounted EV charging station 612.

It should be noted that the disclosure is not limited to the embodiment described and illustrated as examples. A large variety of modifications have been described and more are part of the knowledge of the person skilled in the art. These and further modifications as well as any replacement by technical equivalents may be added to the description and figures, without leaving the scope of the protection of the disclosure and of the present patent.

1. An electric vehicle charging system comprising:
an electric vehicle charging station configured to provide power for a vehicle;
an outdoor media installation functionally associated with the electric vehicle charging station; and
a power source electrically connected with the electric vehicle charging station to provide power thereto.

2. An electric vehicle charging system as in claim 1, wherein the power source comprises a photovoltaic system.

3. An electric vehicle charging system as in claim 2, wherein the photovoltaic system is electrically connected to the electric vehicle charging station via the outdoor media installation.

4. An electric vehicle charging system as in claim 2, wherein the photovoltaic system comprises at least one solar panel physically coupled with the outdoor media installation.

5. An electric vehicle charging system as in claim 4, the outdoor media installation comprising a front face and a rear face, wherein the at least one solar panel is physically coupled with the rear face of the outdoor media installation.

6. An electric vehicle charging system as in claim 5, the photovoltaic system further comprising a tracker system configured to adjust the position of the at least one solar panel with respect to the outdoor media installation.

7. An electric vehicle charging system as in claim 5, wherein a second at least one solar panel is physically coupled with the front face of the outdoor media installation.

8. An electric vehicle charging system as in claim 4, wherein the at least one solar panel is physically coupled with a top portion of the outdoor media installation.

9. An electric vehicle charging system as in claim 2, further comprising a vehicle parking area, wherein the photovoltaic system includes at least one solar panel positioned adjacent to the vehicle parking area.

10. An electric vehicle charging system as in claim 9, wherein the at least one solar panel is positioned above the vehicle parking area.

11. An electric vehicle charging system as in claim 2, wherein the photovoltaic system includes at least one solar panel positioned above the electric vehicle charging station.

12. An electric vehicle charging system as in claim 2, wherein the outdoor media installation is structurally connected with the electric vehicle charging station.

13. An electric vehicle charging system as in claim 12, wherein the photovoltaic system is positioned above the electric vehicle charging station.

14. An electric vehicle charging system as in claim 1, wherein the outdoor media installation includes an electric vehicle charging station notification and the outdoor media installation is positioned with respect to the electric vehicle charging station so as to be able to notify viewers of the electric vehicle charging station notification of the presence of the electric vehicle charging station.

15. An electric vehicle charging system as in claim 1, further comprising a base area configured to provide support for the electric vehicle charging station and the outdoor media installation.

16. An electric vehicle charging system comprising:
an electric vehicle charging station configured to provide power for a vehicle;
an outdoor media installation functionally associated with the electric vehicle charging station;
a photovoltaic system electrically connected with the electric vehicle charging station to provide power thereto; and
a vehicle parking area.

17. An electric vehicle charging system as in claim 16, further comprising a base area configured to provide support for the electric vehicle charging station, the outdoor media installation, and the vehicle parking area.

18. An electric vehicle charging system as in claim 16, wherein the electric vehicle charging station is positioned within the vehicle parking area.

19. An electric vehicle charging system as in claim 16, wherein the photovoltaic system is physically coupled with the outdoor media installation and electrically connected to the electric vehicle charging station.

20. An electric vehicle charging system as in claim 19, further comprising a second photovoltaic system positioned above the electric vehicle charging station and electrically connected to the electric vehicle charging station.

21. An electric vehicle charging system as in claim 20, further comprising a third photovoltaic system positioned above the vehicle parking area and electrically connected to the electric vehicle charging station.

22. A method of supplying power to an electric vehicle charging station comprising:
functionally associating an outdoor media installation with the electric vehicle charging station; and
electrically connecting a power source with the electric vehicle charging station to provide power thereto.

23. A method of supplying power to an electric vehicle charging station as in claim 22, wherein the power source comprises a photovoltaic system and the step of electrically connecting the power source with the electric vehicle charging station includes electrically connecting the photovoltaic system with the with the electric vehicle charging station via the outdoor media installation.

24. A method of supplying power to an electric vehicle charging station as in claim 23, further comprising electrically connecting a second photovoltaic system with the electric vehicle charging station, wherein the second photovoltaic system is positioned above the electric vehicle charging station.

25. A method of supplying power to an electric vehicle charging station as in claim 24, further comprising electrically connecting a third photovoltaic system with the electric vehicle charging station, wherein the third photovoltaic system is positioned above a vehicle parking area adjacent to the vehicle charging station.
